(19) United States
(12) Patent Application Publication
(10) Pub. No.: US 2013/0089831 A1
(43) Pub. Date: Apr. 11, 2013

(54) Perio-Implant Ridge Probe

(71) Applicant: Brian Ehrlich, Suffern, NY (US)

(72) Inventor: Brian Ehrlich, Suffern, NY (US)

(21) Appl. No.: 13/270,424

(22) Filed: Oct. 11, 2011

(51) Int. Cl. A61C 19/04

(52) U.S. Cl. 433/72

(57) ABSTRACT

The invention is a tool that can measure an edentulous ridge and properly locate and or verify new planned dental implant positions. Due to the innovative design of the offset or curved shanks, the invention allows proper positioning of the Perio-Implant Ridge Probe instrument against existing teeth or implants while measuring an edentulous ridge. The invention consists of five separate design types of Perio-Implant Ridge Probes. Each type is an independent instrument with a variation in the design at the working end. The design innovation is in the design of the shank, the ridge probe, and the design of the double ended instruments. The ridge probe is calibrated with millimeter markings and colored bands delineating potential implant locations. The offset shank type design provides for measurements to be attained from either end of the ridge probe. The double ended instruments provide for improved instrument utility.

Instrument allows measuring along an edentulous ridge from the outer surface of a tooth or implant for determining implant placement locations, in relationship to adjacent teeth and or implants.

### BACKGROUND OF THE INVENTION:

In determining implant placement on an edentulous ridge it is important to measure the ridge as it relates to adjoining teeth and or implants that may already exist. Conventional probes do not allow adequate adaptation for measurements because access of the probe to the ridge is not possible due to currently available instrument angulations. A probe that would allow positioning against the existing tooth or implant and be properly positioned against the edentulous ridge would be extremely beneficial for accurately measuring the ridge and verifying proper locations for new implant placements.

### BRIEF SUMMARY OF THE INVENTION

The invention is a newly conceived measurement tool/tools to adequately measure an edentulous ridge and properly locate and or verify new planned implant positions. The invention allows proper positioning of a Perio-Implant measuring probe instrument against the distal, and when necessary with the Offset Shank type design against the mesial aspect of an existing tooth or implant, while allowing the measuring aspect of the instrument to be aligned with the edentulous ridge. Thereby, allowing accurately measuring along the ridge length. This enables the inventions markings and design to determine the proper planned implant locations. The invention consists of five separate types or embodiments of Perio-Implant Ridge Probes. Each type is an independent instrument with a variation at the working end. Each respective type is able to provide the benefits described.

### BRIEF DESCRIPTION OF THE SEVERAL VIEWS OF THE DRAWING

FIG. 1. Represents Offset Shank type (Single Ended). This type Perio-Implant Ridge Probe is a single ended version of the Offset Shank instrument.

FIG. 2. Represents Offset Shank type Double Ended with a Periodontal probe. This type Perio-Implant Ridge Probe is a Double ended instrument version of the Offset Shank type. This type has a conventional periodontal probe attached to the opposing side of the Offset Shank Perio-Implant Ridge Probe instrument.

FIG. 3. Represents Curved Shank type (Single Ended). This type Perio-Implant Ridge Probe is a single ended version of the Curved Shank instrument.

FIG. 4. Represents Curved Shank type Double Ended with a Periodontal probe. This type Perio-Implant Ridge Probe is a Double ended instrument version of the Curved Shank type. This type has a conventional periodontal probe attached to the opposing side of the Curved Shank Perio-Implant Ridge Probe instrument.

FIG. 5A. Represents Curved Shank type (Double Ended) Right and Left sided. This type Perio-Implant Ridge Probe is a right and left sided, Double ended version of the Curved Shank instrument. This figure shows side view of the instrument.

FIG. 5B. Represents Curved Shank type (Double Ended) Right and Left sided. This figure shows end view of the instrument. This view shows the right and left sided aspect of the instrument.

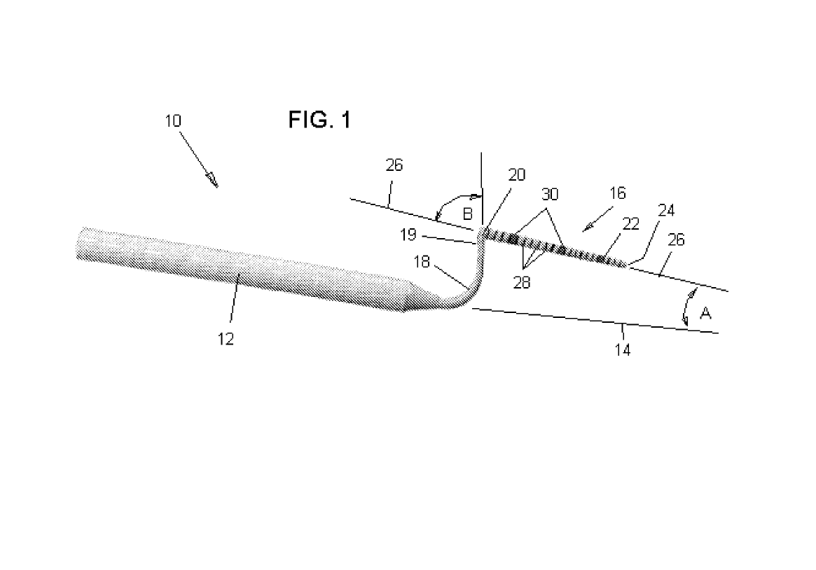

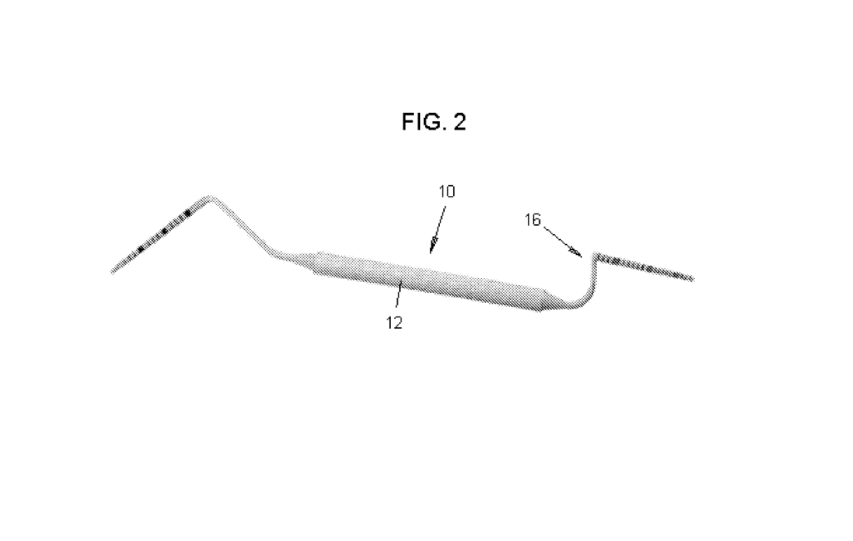

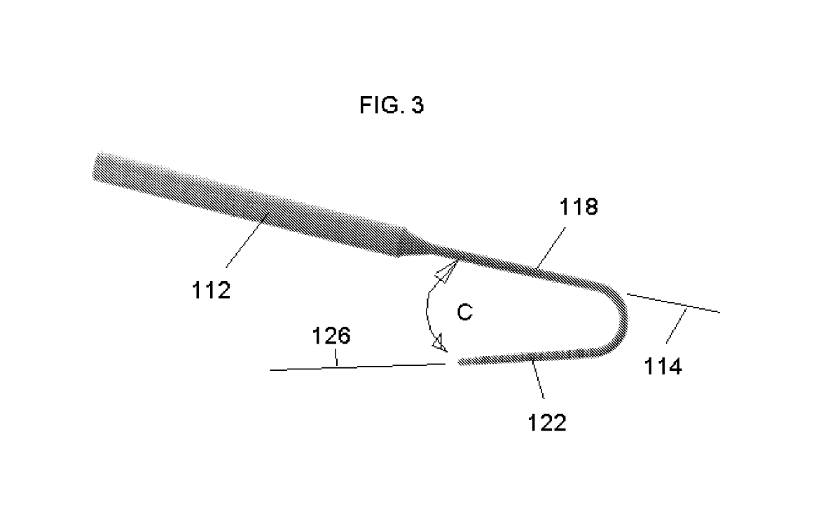

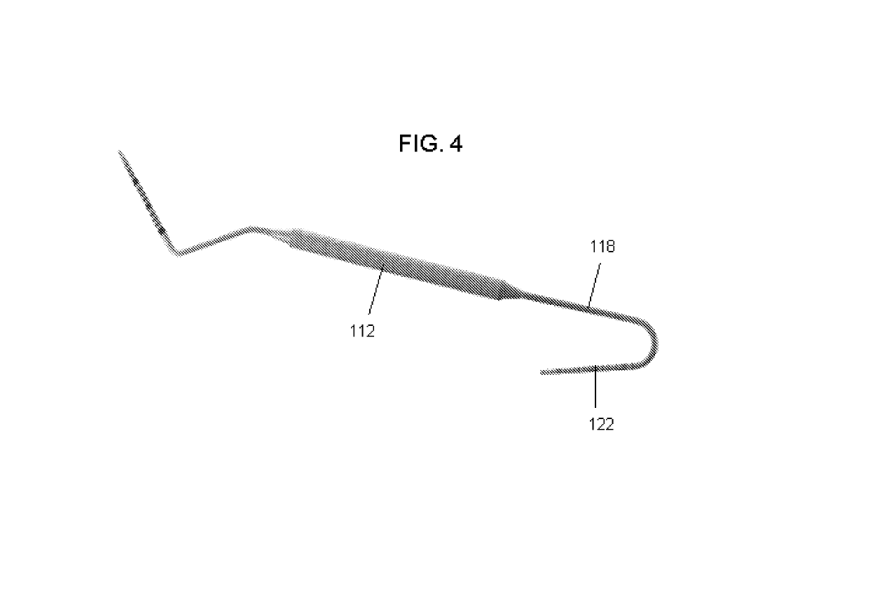

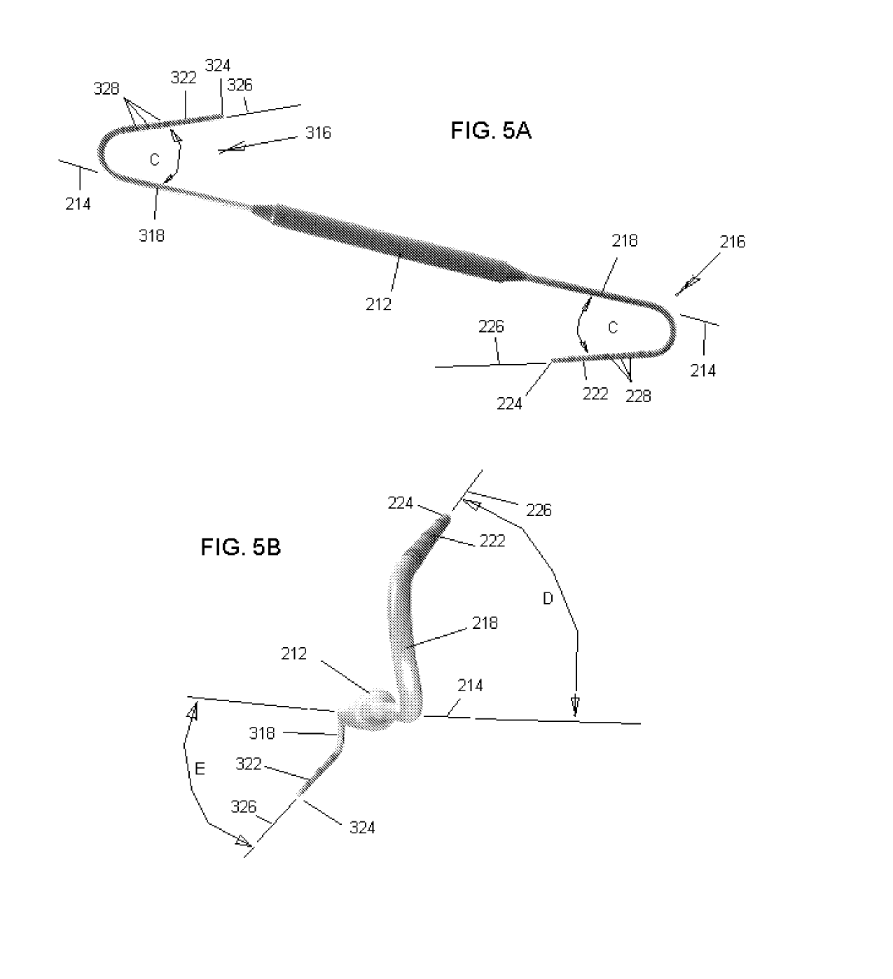

### DESCRIPTION OF THE PREFERRED EMBODIMENT

The invention is a new dental instrument that can be used to measure along an edentulous ridge intra-orally, providing guidance in locating potential dental implant sites. Dental implants are placed into an edentulous ridge following spacing guidelines. These guidelines help the practitioner select the proper sites on an edentulous ridge for implant placement, while providing enough edentulous ridge space to remain between the placed dental implants and/or teeth. The guidelines are based on measurements that separate dental implants and/or teeth by a certain amount of millimeters of space. Implants are separated from teeth by a certain amount of millimeters and implants are separated from other implants by a certain amount of millimeters.

The specific amount of millimeters used can vary depending on the specifics of a patient's case and other determinants. The guidelines in millimeter spacing help the dental practitioner develop the proper amount of spacing required in each individual case. As a general rule, implants sites are located 5 millimeters from the closest aspect of an adjacent tooth, or 7 millimeters from the center of an adjacent implant site.

Currently, when a dentist is measuring along an edentulous ridge to determine potential dental implant sites, the most commonly used instrument is a standard periodontal probe. The standard periodontal probe is a dental hand instrument with a working end that is a calibrated measuring tool. The calibrated markings vary depending on the type desired by the dental practitioner. Most commonly the calibrations are every millimeter or every 3 millimeters, or some combination. The instrument will usually measure up to 10, 12 or 15 millimeters. This instrument was designed for measuring the periodontal sulcus around a tooth. The design of the shank of the standard periodontal probe allows easy positioning of the calibrated working end into the sulcus around each tooth. This positioning allows the calibrated working end to slide vertically down along the tooth root under the gum and measure sulcus depths.

The calibrated working end is designed to measure the sulcus depth and also help delineate depths that are becoming unhealthy. The standard periodontal probe often will have a calibrated mark at the 5 millimeter level to delineate this to the dental practitioner. A sulcus deeper than this level may mean periodontal disease has occurred and the calibrated mark will provide a visual reference. In addition, the calibrations usually extend between 10 and 15 millimeters in length, because most teeth have a root length within this range. Therefore, the design of the current standard periodontal probe is for measuring periodontal health around teeth.

The standard periodontal probe has been applied to dental implants and measuring the edentulous ridge for locating potential dental implant sites. The problem is that the design of this instrument does not allow for proper positioning of the calibrated working end against the edentulous ridge. The further towards the back of the mouth a potential dental implant site is located, the more difficult it becomes to utilize a standard periodontal probe. In addition, the calibrations on the working end are not designed to measure proper implant locations based on established guidelines for implant placement. The calibrated measurements do not highlight potential implant sites based on the guidelines, and the calibrations are not sufficient in length for an edentulous ridge that may require more than two dental implants. The calibrations are also designed to measure only in one direction. The measurement starts at the tip of the calibrated working end and increases in millimeters measured as you move up from the tip towards the shank of the instrument.

The invention is designed to overcome these shortfalls in the existing standard periodontal probe. It is designed to be used specifically for dental implant placement. The new design allows for accessing the edentulous ridge and measuring directly against it. The design allows for positioning against the surface of existing teeth and or implants and measuring along the edentulous ridge to determine potential dental implant sites.

The calibrations have been designed to allow for measuring up to three dental implant sites at a time. The calibrated markings highlight the proper dental implant sites based on guidelines, and the instrument allows the dental practitioner to adjust the measurement if needed to use an alternate site. Another innovative design regarding the Perio-Implant Ridge Probe is that two of the design types allow for measuring in either direction along the calibrated working end. Therefore, measurements can be ascertained by reading from the free end tip of the instrument or from the side where the calibrated working end attaches to the shank of the instrument. This design innovation allows measuring from a mesial or distal point adjacent to the edentulous ridge.

The invention is made from common materials utilized in most dental hand instruments, stainless steel or plastic. The calibrated markings are made in the instrument in the same manner as done for standard periodontal probes. Marks can be grooved into, or raised onto the instrument, or done in colors like black or red. Metal instruments can have anodized color markings placed. An innovation in the markings on the invention is created by incorporating and highlighting guideline areas for potential implant sites.

The invention consists of five types of designs or embodiments. Each design provides for the benefits and innovations mentioned. The five types of designs are as follows: Offset Shank type (Single Ended); Offset Shank type Double Ended with a Periodontal probe; Curved Shank type (Single Ended); Curved Shank type Double Ended with a Periodontal probe; Curved Shank type (Double Ended) Right and Left sided.

### Offset Shank Type (Single Ended)

This design type of the invention consists of three separate sections. The handle, offset shank, and ridge probe. The handle is the same as on existing dental hand instruments. The instrument is a single ended instrument with only one working end. The innovation is present in the design of the offset shank and the ridge probe.

In this design type the offset shank's shape extends the shank out perpendicular to the handle. After the shank rises from the end of the handle a few millimeters, it begins to curve and extend perpendicular to the handle. As the shank lengthens and continues to extend out perpendicular from the handle, the curving causes the extending tip of the shank to decrease in height. Therefore, where the shank stops, it is less millimeters in height away from the start of the shank than is the highest point the shank attained after rising from the handle. This bend is designed to provide clearance for the ridge probe to access the ridge and avoid hitting adjacent structures such as the crowns of teeth.

The extended tip of the shank attaches to the ridge probe. Where the two parts meet the ridge probe is at a 90 degree angle to the shank. The ridge probe extends out from this junction in the same plane as the handle and a parallel direction to it, thereby increasing the overall length of the instrument. At the junction of the shank and ridge probe, the shank's outside border, (meaning the edge and side on the obtuse angle of the junction), becomes flat and distinct. This special design provides a flat surface to exist at this area on the shank, allowing the shank to rest on an adjacent structure like a tooth. In addition this innovation provides for a distinct demarcation on the outside edge between the shank and the ridge probe, thereby establishing an accurate starting point for measurements on the ridge probe.

The ridge probe is innovative due to its design and measuring function. The ridge probe measurements begin at the corner edge of the junction between the shank and the ridge probe. As the probe extends from the shank, the probe displays millimeter markings. The first millimeter marking is the first mark near the shank probe junction. The count in the markings then increases as you move down the extension of the ridge probe. Markings are displayed on the ridge probe every millimeter. The markings extend out either 16 or 23 millimeters from the shank probe junction, depending on the length of ridge probe. The ridge probe can be either 16 or 23 millimeters in length. The markings are made slightly more prominent at the 10, 15 and 20 millimeter marks. In addition, a banded color marking exists between the following marks; 4 and 5; 11 and 12; 18 and 19. These banded color markings represent potential implant locations.

The ridge probe length of 16 and 23 millimeters is also a significant innovation. Although, the shank design enables the ridge probe measurements to start at the junction of the shank and the ridge probe, the measurements can also begin at the ridge probe free end. The ridge probe measurement markings go to the free end of the ridge probe. The innovative 16 or 23 millimeter length of the ridge probe in combination with the previously mentioned placement of the color banded marks, allows measuring from either end of the ridge probe. This specific combination allows determining potential implant placement locations from the free end of the probe as well as from the shank probe junction.

Offset Shank Type Double Ended with a Periodontal Probe

This type has all the same features and innovations criteria as the before mentioned Offset Shank type Perio-Implant Ridge Probe, with the addition of a fourth section. This forth section is created by the addition of a conventional 15 millimeter periodontal probe to the instrument handle.

This design type of the implant ridge probe gains additional function by creating the instrument as a double ended instrument. The instrument becomes a double ended instrument by adding a standard periodontal probe to the opposite end of the instrument handle. This addition allows the user to quickly change from the implant ridge probe to a standard periodontal probe when clinically necessary. This innovation provides the Perio-Implant Ridge Probe with greater utility.

### Curved Shank Type (Single Ended)

This design type of the invention consists of three separate sections. The handle, curved shank, and ridge probe. The handle is the same as on existing dental hand instruments. This design type instrument is a single ended instrument with only one working end. The innovation is present in the design of the curved shank and the ridge probe.

The shank of the Curved Shank type is designed to be elongated and end in a curved shape. The shank rises from the handle and extends a length slightly longer than the length of the ridge probe before it begins to curve. The length of the shank is approximately 30 millimeters before it begins to curve on a 20 millimeter ridge probe. A 15 millimeter ridge probe would have a shank of approximately 25 millimeters in length before it begins to curve. The curved aspect of the shank creates up to a 15 degree divergence between the shank and the ridge probe. The handle, shank and ridge probe in this type of invention are all in the same dimensional plane.

The ridge probe is innovative in its design and measuring capabilities due to the ridge probe position as it extends from the curved aspect of the shank, and as it relates to the invention handle. The angulated position of the ridge probe from the elongated and curved shank, provides an efficient, convenient, and accurate means in which to place the free end of the ridge probe on an edentulous ridge and against the distal surface of a tooth or implant.

The markings on the Curved shank type design ridge probe begin measurements in millimeters at the free end of the probe. Darker markings exist at the 10, 15 and 20 millimeter marks. A banded color marking exists between the following marks; 4 and 5; 11 and 12; 18 and 19. These banded marks represent potential implant locations. Curved shank type Perio-implant ridge probes with a 15 millimeter length ridge probe will have two color bands, and a 20 millimeter length ridge probe will have three color bands.

Curved Shank Type Double Ended with a Periodontal Probe

This type has all the same features and innovations as the before mentioned Curved Shank type Perio-Implant Ridge Probe, with the addition of a fourth section. This forth section is created by the addition of a conventional 15 millimeter periodontal probe to the instrument handle.

This design type of the Perio-Implant Ridge Probe gains additional function by creating the instrument as a double ended instrument. The instrument becomes a double ended instrument by adding a standard periodontal probe to the opposite end of the instrument handle. This addition allows the user to quickly change from the implant ridge probe to a standard periodontal probe when clinically necessary. This innovation provides the perio-implant ridge probe with greater utility.

### Curved Shank Type Double Ended Right and Left Sided

This design type of the invention consists of five separate sections: The handle; Two curved shanks, one right handed and one left handed; Two ridge probes. The handle is the same as on existing dental hand instruments. This design type instrument is a double ended instrument with two working ends. The innovation is present in the design of the curved shank and the ridge probe.

This type has many similar features and innovations as the before mentioned Curved Shank Type Single Ended Perio-Implant Ridge Probe, plus the addition of the following innovations. The instrument is double ended with each end having a curved shank with a ridge probe. Each shank gains an additional offset bend. The offset bend to the shank begins at the start of the curved section after the elongated section of the shank. The bend can be up to a 30 degree offset to the plane of the elongated portion of the shank. This bend allows the ridge probe to be offset to either the right or left side of the linear direction and plane of the handle and elongated portion of the shank. Each curved shank is bent to the opposite side of the other. This allows creating a double ended instrument with a right and left handed bent curved shank.

The ridge probe itself has all the same features and innovations as the before mentioned Curved Shank ridge probe.

1-6. (canceled)

7: A measuring instrument for locating potential dental implant sites on an edentulous ridge, comprising:
a handle (112, 212) having opposite ends and a handle axis (114, 214); and
a measuring probe connected at one end of the handle;
the measuring probe comprising:
an elongated transition portion (118, 218) having a first end connected to the one end of the handle, a straight portion extending from the first end of the transition portion, and a curved portion extending from the straight portion, the curved portion having a second end that is spaced from the handle axis, and
an elongated transition portion (122, 222) having a first end connect to the second end of the transition portion and a second free end, the measuring portion extending alone an acute pathway (126, 226) that is at an acute angle (C) to the handle axis and being adapted to lay along an edentulous ridge with a second free end engaging against a tooth or implant adjacent the edentulous ridge, the measuring portion including a plurality of equally spaced calibrated marks between the first end of the measuring portion and the second free end of the measuring portion for locating a potential dental implant site on the edentulous ridge.

8: The measuring instrument of claim 7, wherein the plurality of equally spaced calibrated marks include a plurality of spaced highlighted marks along the measuring portion that are space from each other by a plurality of calibrated marks for locating plural spaced potential dental implant sites on the edentulous ridge.

9: The measuring instrument of claim 7, wherein the plurality of equally spaced calibrated marks include a plurality of spaced highlighted marks along the measuring portion that are space from each other by a plurality of calibrated marks for locating plural spaced potential dental implant sites on the edentulous ridge, each highlighted mark comprising a contrasting band between two adjacent calibrated marks.

10: The measuring instrument of claim 7, wherein the straight portion of the transition portion extends parallel to the handle axis and the second end of the curved portion extends at an acute angle (D) to the acute pathway (226).

11: The measuring instrument of claim 10, wherein the measuring portion (222) extends along the acute pathway away from the handle.

12-14. (canceled)

15: The measuring instrument of claim 7, including a second (316) measuring probe connected at an opposite end of the handle (212) from the one end, the second measuring probe comprising, a second elongated transition portion having a first end connect to the opposite end of the handle and a second end that is spaced from the handle axis, and a second elongated measuring portion having a first end connect to the second end of the second transition portion and a second free end, the second measuring portion extending alone a second acute pathway that is at an acute angle to the handle axis and is adapted to lay along an edentulous ridge with the second free end engaged against a tooth or implant adjacent the edentulous ridge, the second measuring portion including a second plurality of equally spaced calibrated marks between the first end of the second measuring portion and the second free end of the second measuring portion for locating a potential dental implant site on the edentulous ridge, each of the first-mentioned and second transition portions being at least partly curved, the first ends of each of the first-mentioned and second transition portions extending parallel to the handle axis and the second ends of each of the first-mentioned and second transition portions extending along the respective first-mentioned and second acute pathways, the first-mentioned and second measuring portions each extending toward the handle.

16: The measuring instrument of claim 7 including a second measuring probe connected at an opposite end of the handle from the one end the second measuring probe comprising, a second elongated transition portion having a first end connect to the opposite end of the handle and a second end that is spaced from the handle axis, and a second elongated measuring portion having a first end connect to the second end of the second transition portion and a second free end, the second measuring portion extending alone a second acute pathway that is at an acute angle to the handle axis and is adapted to lay along an edentulous ridge with the second free end engaged against a tooth or implant adjacent the edentulous ridge, the second acute pathway extending on an opposite side of the handle axis from the first-mentioned acute pathway, the second measuring portion including a second plurality of equally spaced calibrated marks between the first end of the second measuring portion and the second free end of the second measuring portion for locating a potential dental implant site on the edentulous ridge, each of the first-mentioned and second transition portions being at least partly curved, the first ends of each of the first-mentioned and second transition portions extending parallel to the handle axis and the second ends of each of the first-mentioned and second transition portions extending along the respective first-mentioned and second acute pathways the first-mentioned and second measuring portions each extending along the acute pathway toward the handle, on opposite sides of the handle axis for right handed and for left handed use.

17: The measuring instrument of claim 7, including a second measuring probe (316) connected at an opposite end of the handle (212) from the one end, the second measuring probe comprising, a second elongated transition portion (318) having a first end connect to the opposite end of the handle and a second end that is spaced from the handle axis (214) and a second elongated measuring portion (322) having a first end connect to the second end of the second transition portion (318) and a second free end (324), the second measuring portion extending alone a second acute pathway (326) that is at an acute angle (C) to the handle axis (214) and is adapted to lay along an edentulous ridge with the second free end engaged against a tooth or implant adjacent the edentulous ridge, the second acute pathway extending on an opposite side of the handle axis (214) from the first-mentioned acute pathway (226), the second measuring portion including a second plurality of equally spaced calibrated marks (328) between the first end of the second measuring portion and the second free end of the second measuring portion for locating a potential dental implant site on the edentulous ridge, each of the first-mentioned and second transition portions being at least partly curved, the first ends of each of the first-mentioned and second transition portions extending parallel to the handle axis and the second ends of each of the first-mentioned and second transition portions extending along the respective first-mentioned and second acute pathways, the first-mentioned and second measuring portions each extending along the acute pathway toward the handle, on opposite sides of the handle axis for right handed and for left handed use, the handle axis (214) lying in a plane and the first-mentioned (226) and second acute pathways (326) extending at opposite acute angles (D, E) to the plane on opposite sides of the handle axis (214).
